(19) United States
(12) Patent Application Publication
(10) Pub. No.: US 2012/0139299 A1
(43) Pub. Date: Jun. 7, 2012

(54) Collapsible Roof Device for a Long Vehicle Such a Touristic Bus

(75) Inventor: Rita Vila Pascual, Girona (ES)

(73) Assignee: Carrocerias Ayats, S.A., Girona (ES)

(21) Appl. No.: 13/382,015

(22) PCT Filed: Jun. 22, 2010
(86) PCT No.: PCT/IB10/01503

§ 371 Date: Feb. 20, 2012

(30) Foreign Application Priority Data
Jul. 6, 2009 (EP) 09380128.0

(51) Int. Cl. B60J 7/047

(52) U.S. Cl. 296/220.01

(57) ABSTRACT

The invention relates to a sliding roof device for a long vehicle, applicable to a sightseeing bus. The roof comprises sliding cover elements (2) movable between an extended position, in which they cover an opening in the roof of the vehicle, and a retracted position which leaves said opening of the vehicle uncovered, and in which the cover elements (2) are superimposed and supported on a pivoting structure (3), at one end of the long vehicle (50). The pivoting structure can swing between an unfolded position and a folded position in which the cover elements (2) are withdrawn. The pivoting structure (3) has, close to a front end, followers (6) arranged to run along horizontal longitudinal folding guides (7) and, close to a rear end, articulations (20) connected to driving arms (8) pivotable about a transverse horizontal shaft (9) located below said folding guides (7) by the drive of an actuator.

### FIELD OF THE ART

The present invention relates to a sliding roof device for a long vehicle, applicable for example to sightseeing buses or coaches, and to other long vehicles such as railway wagons, ships, etc. in which it is of interest to clear the roof surface to facilitate a better view of surroundings which are being visited.

### BACKGROUND OF THE INVENTION

Patent EP-A-0827856 discloses a bus for sightseeing tours provided with a sliding roof formed by a flexible canopy fixed on bars arranged to move along guide rails to cover or uncover an opening in the roof of the vehicle.

Patent EP-A-1332904 describes a telescopic cover for covering relatively large areas. The cover comprises a plurality of cover elements movable between an extracted position, in which they cover the area, and a retracted position, in which they occupy a reduced collecting area. The cover elements comprise a cover panel and at least one front sliding foot and one rear sliding foot on each side, said sliding feet being arranged to run along lateral guide elements. The cover elements are identical to one another and, in the extended position, at least one cover element rests on the guide element with rear sliding feet and is supported with a front edge on a rear edge of an adjacent cover element. A drawback of this telescopic cover is that it does not allow substantially uncovering the entire area that it is capable of covering due to the fact that when the plurality of cover elements are superimposed in the retracted position, they always occupy a significant portion of the area.

Patent FR-A-2913373 discloses a sliding roof for a utility automobile. The sliding roof comprises several cover panels movable between an extended position, in which they cover an opening in the roof of the passenger compartment, and a retracted position on a support structure, which is associated with means for supporting and guiding the support structure together with the cover panels between the retracted position, an intermediate position located above a trunk compartment, and a considerably horizontal folded position at the upper part of said trunk compartment. Driving means are arranged to move the support structure together with the cover panels between the different positions. The supporting and guiding means comprise, on each side of the vehicle, a follower connected to the support structure cooperating with a longitudinal rail to guide the support structure together with the cover panels between the retracted and intermediate positions, a pivoting telescopic arm having a first end connected in an articulated manner to the rear part of the support structure and another end connected in an articulated manner to the structure of the vehicle, a follower connected to said pivoting telescopic arm cooperating with a rail with a shape adapted to continuously guide the support structure together with the cover panels between the retracted, intermediate and folded positions, and means for reducing the trajectory of said driving means.

The sliding roof described in the mentioned patent FR-A-2913373 has several drawbacks. Firstly, the supporting, guiding and driving means for moving the support structure together with the cover panels between the different positions form an extremely complex assembly which can be expensive to manufacture and maintain. Furthermore, the support structure together with the cover panels are supported in cantilever by the pivoting telescopic arm during its movements between the intermediate and folded positions, and this forces oversizing the supporting, guiding and driving means to withstand the forces to which they are subjected. In addition, the considerably horizontal position at a lower level than the roof of the vehicle reached by the support structure together with the cover panels in the folded position has little application in the field of long vehicles, such as sightseeing buses or coaches, since it imposes assembly storing conditions with a reduction of the useful space.

### DISCLOSURE OF THE INVENTION

The present invention contributes to mitigating the previous and other drawbacks by providing a sliding roof device for a long vehicle, applicable to a sightseeing coach or bus, of the type comprising a plurality of sliding cover elements arranged to move between an extended position, in which said cover elements are arranged one after another covering an opening in the roof of the long vehicle, and a retracted position which leaves a large part of said opening in the roof of the long vehicle uncovered, and in which the cover elements are mutually superimposed or fitted in a compact arrangement supported by a pivoting structure, which is installed at an end of the long vehicle such that it can pivot between an unfolded position, in which said pivoting structure together with the cover elements cover a portion of the opening in the roof of the long vehicle, and a folded position, in which the pivoting structure together with the cover elements are in a withdrawn position at said end of the long vehicle. The sliding roof device is characterized in that the pivoting structure has, close to a front end, followers arranged to run along substantially horizontal longitudinal folding guides and, close to a rear end, one or more articulations connected to respective driving arms installed such that it can pivot about a transverse horizontal shaft located at a lower level than said folding guides under the drive of an actuator.

With this construction, the pivoting structure has at all times, including the stage of its movements between the unfolded and folded positions, its front end supported on the folding guides and its rear end supported by the driving arms. This allows the mechanisms for supporting, guiding and driving the movements of the pivoting structure together with the cover elements between the unfolded and folded positions to be extremely simple and lightweight, and therefore have a low cost, the maintenance likewise being minimized. These mechanisms further allow the pivoting structure together with the cover elements to reach a substantially vertical position at a rear end of the long vehicle when they are in said folded position, which is very advantageous in the case of a sightseeing bus or coach since they leave substantially the entire opening in the roof thereof uncovered.

### BRIEF DESCRIPTION OF THE DRAWINGS

The previous and other features and advantages will be more fully understood from the following detailed description of an embodiment with reference to the attached drawings, in which:

FIG. 1 is a schematic and partial perspective view of a long vehicle, such as a sightseeing bus, showing a sliding roof, according to the invention;

FIG. 2 is a perspective view of a pivoting structure, comprising side flanges in which there are defined guide elements for receiving the cover elements, in an inserted arrangement and superimposed, according to a compact formation;

FIG. 3 is a perspective view of one of the cover elements forming the sliding roof;

FIG. 4 is an elevational view of the vehicle with an enlarged detail of the means for moving the pivoting structure between its projecting extended position forming the rear part of the roof of the vehicle, and a substantially vertical retracted position, placed against the rear wall of said vehicle;

FIGS. 5 to 8 are respective perspective views showing, step by step, the movements of the pivoting structure between the two mentioned limit positions, still operating as a cover on the rear part of the vehicle, and retracted, completely clearing the rear part of the roof of the vehicle, and integrating therein the series of mentioned sliding cover elements, acting as a bearing module.

### DETAILED DESCRIPTION OF AN EXEMPLARY EMBODIMENT

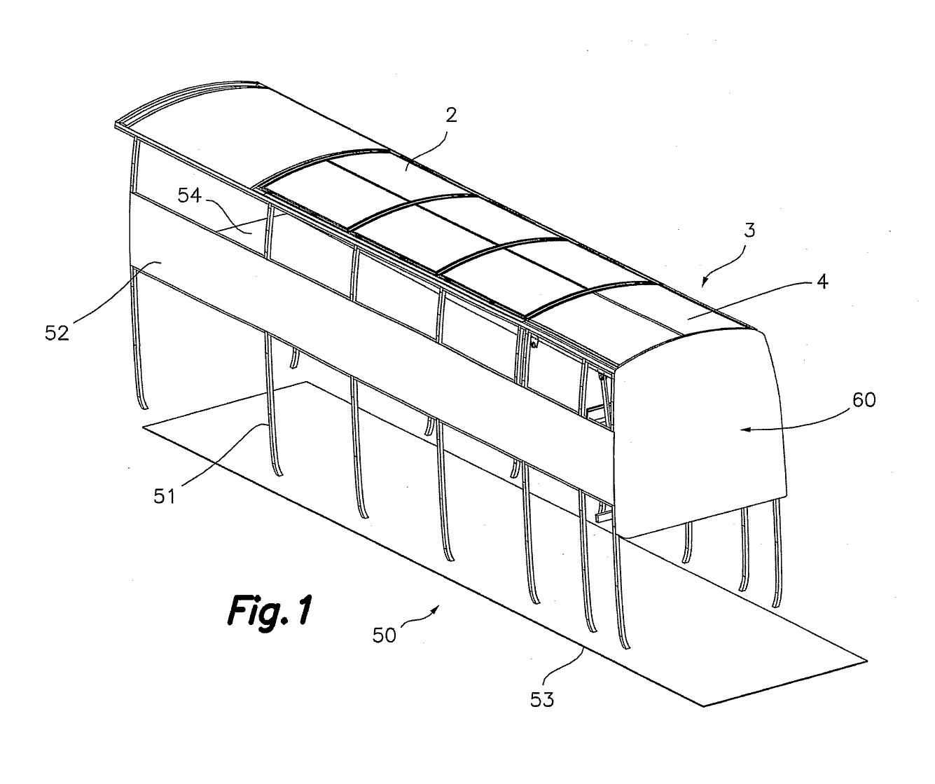

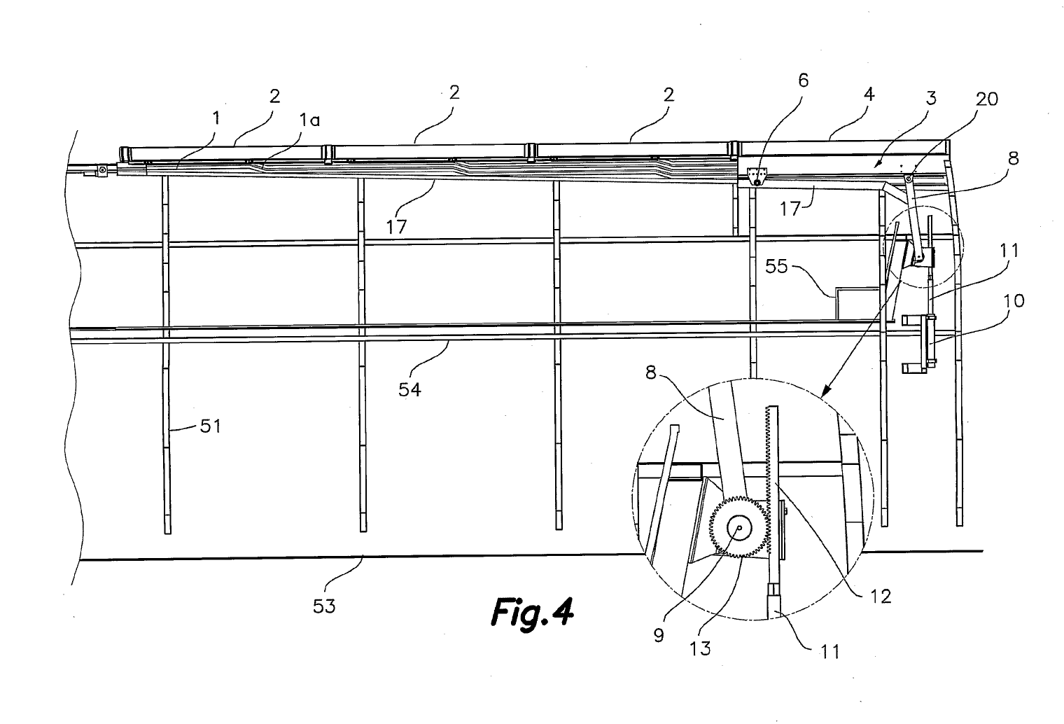

The sliding roof device for a long vehicle of this invention is of the type described in patent FR-A-2913373 (although this document describes a utility vehicle) and thus comprises a plurality of sliding cover elements 2 (see FIGS. 1 and 4) arranged to move between an extended position, in which said cover elements 2 are arranged one after another covering an opening in the roof of the vehicle, and a retracted position which leaves a large part or all of said opening in the roof of the vehicle uncovered, the cover elements 2 then being mutually superimposed or fitted in a compact arrangement supported by a pivoting structure 3. This pivoting structure, according to the mentioned state of the art, is usually installed at a rear end of the vehicle such that it can pivot between an unfolded position, in which said pivoting structure 3 together with the cover elements 2 cover a portion of the opening in the roof of the vehicle, and a folded position, in which the pivoting structure 3 together with the cover elements 2 are in a withdrawn position at said rear end of the vehicle, having to provide a storage area for that purpose.

The device of the invention has been designed for its application to a long vehicle 50, such as a sightseeing bus which has been schematically shown in FIG. 1, comprising structural struts 51, a lower floor 53, an upper floor 54 delimited by side walls 52, which can be occupied by the users in order to considerably improve the conditions for viewing the surroundings from said raised position, it being important in said case to maximally clear any obstacle, such as a roof of the vehicle if the weather conditions allow it.

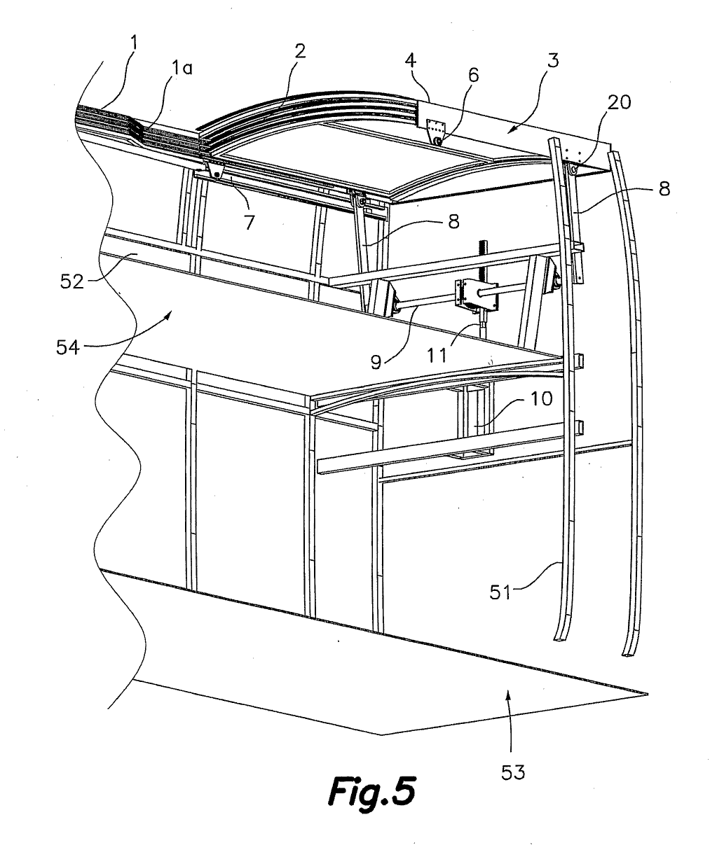

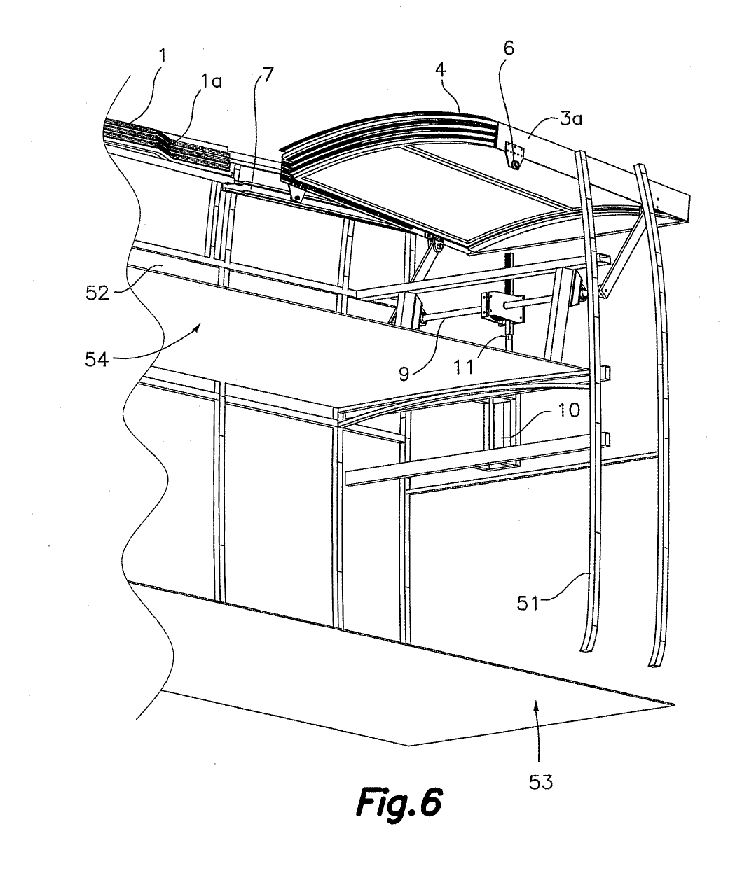

According to the invention, a pivoting structure 3 is provided, located at the rear part of the vehicle and provided close to a front end with followers 6 (for example, wheels) arranged to run along substantially horizontal longitudinal folding guides 7 (see FIGS. 5 and 6) and close to a rear end with articulations 20 connected to respective driving arms 8 installed such that they can pivot about a transverse horizontal shaft 9 located at a lower level than said folding guides 7 under the drive of an actuator.

The actuator comprises a hydraulic cylinder 10 the rod 11 of which is connected to a rack 12 meshed with a gear wheel 13 fixed to said shaft 9 or to said driving arm 8 as can be seen in the enlarged detail of FIG. 4.

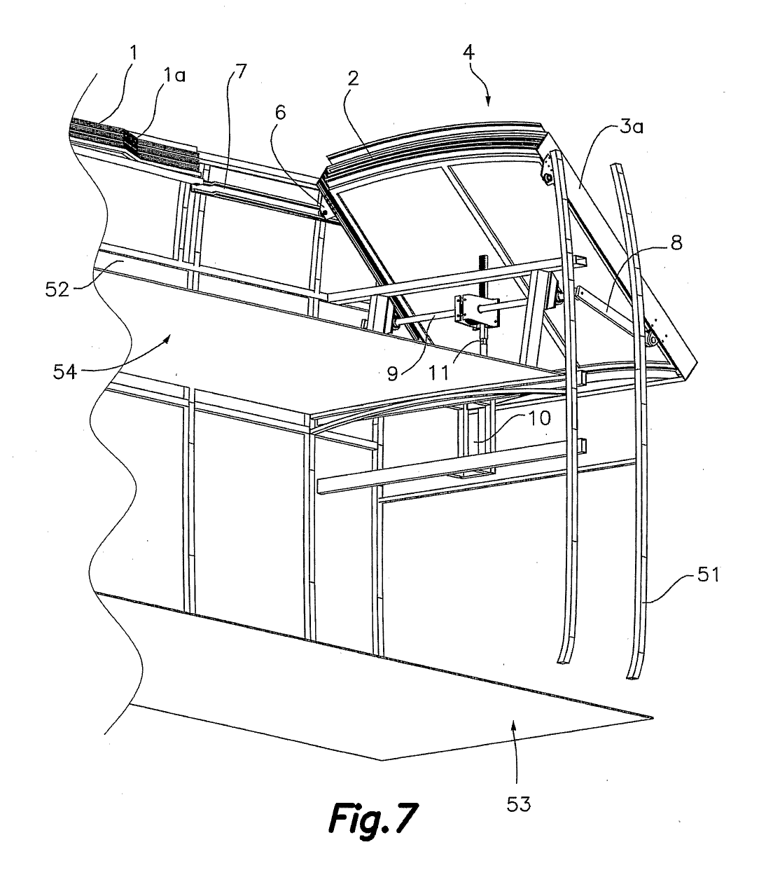

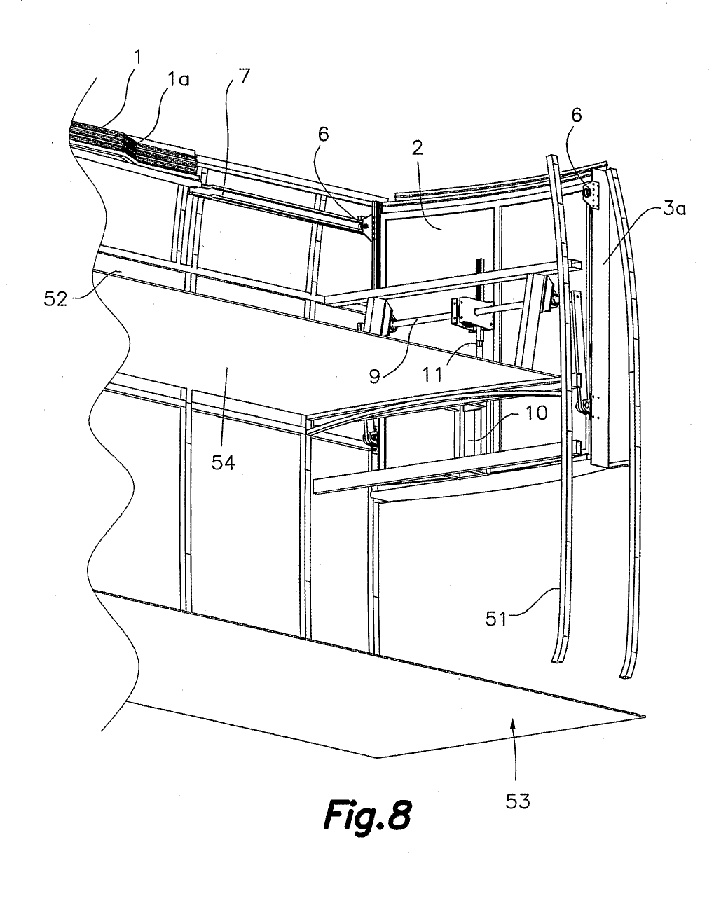

This special organization of the guide means and of the drive or thrust mechanism of the structure provides a safe and effective drive of the assembly, bearing in superposition the series of cover elements 2 (see FIGS. 5 to 7) duly supported at all times. Furthermore, the pivoting structure 3 together with the plurality of cover elements 2 supported by it adopt a substantially vertical position at a rear end of the long vehicle 50 when they are in said folded position, such that the vertical position next to the back 60 of the long vehicle 50 completely clears the roof of the vehicle and minimizes the useful space to be reserved for storing the pivoting structure 3, in its concealed state.

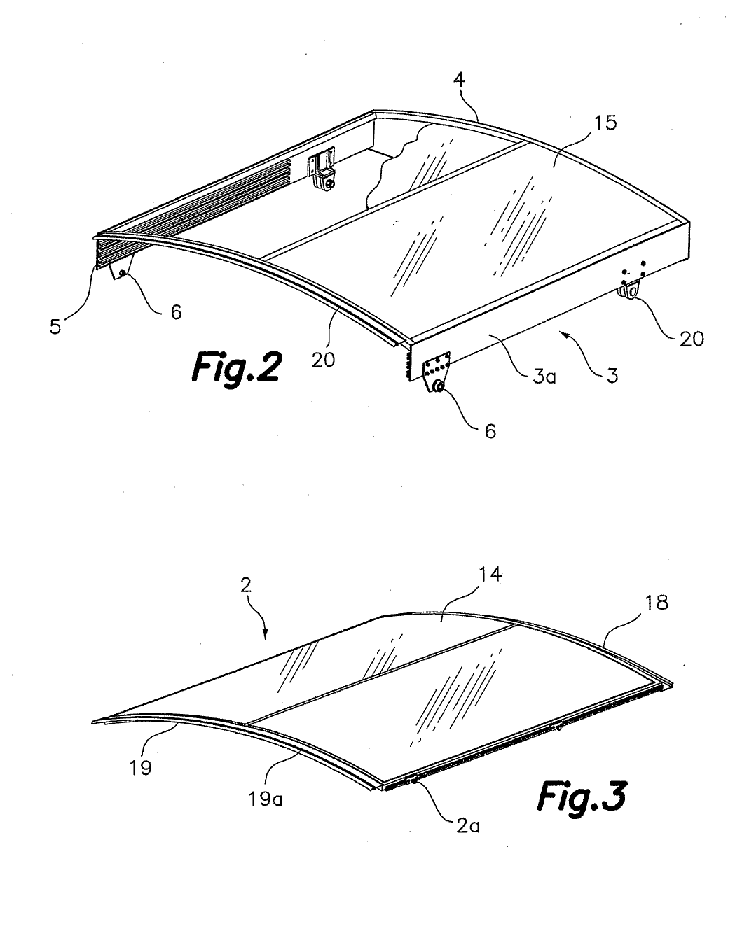

The cover elements 2 are arranged to move (for example, by traction means such as a chain or flexible element and a linear actuator, according to the state of the art) along a plurality of first guide elements 1 between said extended and retracted positions, and the pivoting structure 3 is provided with an upper cover element 4 and second guide elements 5 (see FIG. 2) defined in the inner face of side flaps 3a, such that, when said pivoting structure 3 is in said unfolded position (FIG. 5), said upper cover element 4 covers a portion of the opening in the roof of the long vehicle 50 and said second guide elements 5 are correspondingly aligned with said plurality of first guide elements 1 and arranged to receive the cover elements 2 under said upper cover element 4 of the pivoting structure 3.

As can be seen in FIG. 4, the first guide elements 1 include sloping sections 1a to successively guide each of the cover elements 2 under the adjacent cover element 2 when the cover elements 2 are moved from the extended position to the retracted position, until the plurality of cover elements 2 are arranged one under another and under the upper cover element 4 in the pivoting structure 3 (FIG. 5), forming a compact package.

FIG. 3 shows one of the cover elements 2 (all of them are initially identical, although they could have a different length) which includes one or more curved cover panels 14, with a central part that is more raised than longitudinal side edges in which there are included small wheels 2a or a follower element to move over the mentioned guides 1, 1a in the sides.

The upper cover element 4 of the pivoting structure 3 in turn comprises, as shown in FIG. 2, one or more curved cover panels 15, with a central part that is more raised than longitudinal side edges in which it is finished by the mentioned flaps 3a.

In a preferred embodiment, the first and second cover panels 14, 15 are transparent.

As can be seen in FIG. 3, each of the first cover elements 2 has at one end a wide transverse channel 18 for collecting and draining water and at the other opposite end a small roof 19, with a narrow transverse channel 19a, for drainage (to facilitate the insertion in the mentioned guides 1, 1a without jams), arranged to cover a joint between the first cover element 2 and another adjacent first cover element 2.

Furthermore, under the first guide elements 1 and the folding guides 7 there are arranged water draining channels 17 to collect the water falling on the first and second cover elements 2, 4 when they are in the extended position and draining it out of the long vehicle 50 through a suitable conduit, not shown. Said water draining channels 17 form a base for supporting the assembly of mentioned guide elements 1, 5.

The pivoting structure 3 comprises, under the upper cover element 4, side skirts or flaps 3a supporting the second guide elements 5 and between which (in the inner face thereof provided with a plurality of opposite grooves) there is housed the plurality of cover elements 2 one under another in the retracted position.

As shown in FIG. 2, the pivoting structure 3 has at one end a small roof 20 arranged to cover a joint between the pivoting structure 3 and an adjacent first cover element 2.

1. A sliding roof device for a long vehicle, applicable to a sightseeing bus, of the type comprising a plurality of sliding cover elements arranged to move between an extended position, in which said cover elements are arranged one after another covering an opening in the roof of the vehicle, and a retracted position which leaves a large part of said opening in the roof of the vehicle uncovered, in which the cover elements are mutually superimposed or fitted in a compact arrangement supported by a pivoting structure, which is installed at an end of the long vehicle such that it can pivot between an unfolded position, in which said pivoting structure together with the cover elements cover a portion of the opening in the roof of the vehicle, and a folded position, in which the pivoting structure together with the cover elements are in a withdrawn position at said end of the vehicle, wherein the pivoting structure has, close to a front end, followers arranged to run along substantially horizontal longitudinal folding guides and, close to a rear end, at least one articulation connected to a driving arm installed such that it can pivot about a transverse horizontal shaft located at a lower level than said folding guides under the drive of an actuator.

2. The device according to claim 1, wherein the pivoting structure together with the plurality of cover elements supported by it adopt a substantially vertical position at a rear end of the long vehicle when they are in said folded position.

3. The device according to claim 2, wherein the cover elements are arranged to move along a plurality of first guide elements between said extended and retracted positions, and the pivoting structure is provided with an upper cover element and second guide elements, such that, when said pivoting structure is in said unfolded position, said upper cover element covers a portion of the opening in the roof of the long vehicle and said second guide elements are correspondingly aligned with said plurality of first guide elements and arranged to receive the cover elements under said upper cover element of the pivoting structure.

4. The device according to claim 3, wherein said first guide elements include sloping sections (Ia) to successively guide each of the cover elements under the adjacent cover element when the cover elements are moved from the extended position to the retracted position, until the plurality of cover elements are arranged one under another and under the upper cover element in the pivoting structure.

5. The device according to claim 3, wherein each of the cover elements has at least one curved cover panel, with a central part that is more raised than longitudinal side edges, and the upper cover element of the pivoting structure comprises at least one curved second cover panel, with a central part that is more raised than longitudinal side edges.

6. The device according to claim 5, wherein the pivoting structure comprises, under the upper cover element, side skirts supporting the second guide elements and between which there is housed the plurality of cover elements one under another in the retracted position.

7. The device according to claim 6, wherein the first and second cover panels are transparent.

8. The device according to claim 1, wherein said actuator comprises a hydraulic cylinder the rod of which is connected to a rack meshed with a gear wheel fixed to said shaft or to said driving arm.

9. The device according to claim 3, wherein each of the first cover elements has at a first end a transverse channel for collecting and draining water and at the other opposite end a small roof arranged to cover a joint between the first cover element and another adjacent first cover element.

10. The device according to claim 9, wherein a groove for collecting and draining water has been provided in said small roof.

11. The device according to claim 9, wherein under the first guide elements and the folding guides there are arranged water draining channels to collect the water falling on the first and second cover elements when they are in the extended position and draining it out of the long vehicle.

12. The device according to claim 3, wherein the pivoting structure has at one end a small roof arranged to cover a joint between the pivoting structure and an adjacent first cover element.
